(19) United States
(12) Patent Application Publication
(10) Pub. No.: US 2026/0035549 A1
(43) Pub. Date: Feb. 5, 2026

(54) LOW-DENSITY POLYETHYLENE/ELEMENTAL SULFUR HYBRID COMPOSITE ELECTRODE MATERIAL FOR SUPERCAPACITORS

(71) Applicant: Khalifa University of Science and Technology, Abu Dhabi (AE)

(72) Inventors: Saeed Alhassan ALKHAZRAJI, Abu Dhabi (AE); Kishore JENA, Abu Dhabi (AE)

(21) Appl. No.: 19/358,670

(22) Filed: Oct. 15, 2025

Related U.S. Application Data
(62) Division of application No. 17/846,609, filed on Jun. 22, 2022.

(51) Int. Cl. C08L 23/06; H01G 11/48; H01M 4/60; H01M 4/66

(52) U.S. Cl. CPC C08L 23/06; H01G 11/48; H01M 4/604; H01M 4/665; C08L 2207/066

(57) ABSTRACT

Embodiments of the present disclosure describe a hybrid composite material comprising a polymer matrix and elemental sulfur substantially uniformly dispersed in the polymer matrix, wherein the polymer is a branched polymer. Electrochemical devices, which may be fabricated from the hybrid composite material, adsorbents comprising the hybrid composite materials, and methods of using the devices and adsorbents are also provided.

### CROSS-REFERENCE TO RELATED APPLICATIONS

This application is a Divisional of U.S. application Ser. No. 17/846,609, titled “LOW-DENSITY POLYETHYLENE/ELEMENTAL SULFUR HYBRID COMPOSITE ELECTRODE MATERIAL FOR SUPERCAPACITORS”, filed Jun. 22, 2022, the contents of which are incorporated by reference herein. A claim of priority is made.

### BACKGROUND

Supercapacitors are class of energy storage systems with high energy density and high power density along with long life-cycle and fast charge-discharge capabilities. Electrodes used in supercapacitors are fabricated from different materials including ceramics and polymers. For the latter, many different polymers have been used as electrodes including: polyaniline (PANI), polypyrrole (PPy), polythiophene (PTh) and poly(3,4-ethylenedioxythiophene) polystyrene sulfonate (PEDOT:PSS). These polymers are expensive, highly specialized, and difficult to process into many engineering structures, however.

Hybrid composite material properties can be enhanced through the combination of anticipated properties from each material. For example, the addition of fillers in the polymer matrix to improve composite materials properties is a focus of industry and research. Improving the dispersion of fillers in the polymer matrix has generated substantial interest for several applications. Inorganic fillers such as silica, ZnO, iron oxide, TiO₂, calcium carbonate, and mica provide excellent thermo-mechanical properties, but are expensive. Recently renewable resource fillers, such as clay and fibers which are available in high abundance, less expensive and eco-friendly, have been explored. The hybrid composite properties depend on the filler chemical structure and particles distribution in the polymer matrix. LDPE-clay nanocomposites show remarkable improvement in thermo-mechanical properties compared to pristine polymers.

For potential electrical and thermally conductive hybrid materials, composites containing conducting carbon such as graphene, carbon nanotube (CNT) structures have attracted considerable research interest. The conducting carbon materials such as graphene, CNTs possess unique properties, which make hybrid composite materials suitable for different functional applications. The interaction of filler and matrix in the hybrid materials from π-π stacking has been suggested to increase the overall properties of the hybrid materials.

Elemental sulfur represents a largely unutilized resource for high performance materials development. Multiple oxidation states of sulfur (+6, 5, 4, 3, 2, 1, −1 and −2) are useful for reversible redox response for energy storage. While the cost-effectiveness, nonabrasive, high filling levels and mechanical properties, and high abundance would make sulfur a promising filler in hybrid composite materials, the morphology, structural arrangement and mechanical properties of the composites using sulfur as filler have not been investigated thoroughly.

### SUMMARY

In general, embodiments of the present disclosure describe a hybrid composite material comprising a branched polyethylene (e.g., Low Density Polyethylene (LDPE)) and sulfur which overcomes the limitations of previously described electrode materials.

The details of one or more examples are set forth in the description below. Other features, objects, and advantages will be apparent from the description and from the claims.

### BRIEF DESCRIPTION OF DRAWINGS

The application file contains at least one drawing executed in color. Copies of this patent or patent application publication with color drawing(s) will be provided by the Office upon request and payment of the necessary fee.

This written disclosure describes illustrative embodiments provided in the accompanying drawings, in which:

FIGS. 1A-C show differential scanning calorimetry (DSC) traces for heating and cooling cycles of LDPE-S materials, according to one or more embodiments of the present disclosure: Differential scanning calorimetry (DSC) traces for (A) a first heating and cooling cycle; (B) a second heating and cooling cycle; (C) a third heating and cooling cycle. Melting endotherms (up) and crystallization exotherms (down).

FIG. 1D shows a heating and cooling cycle of sulfur and LDPE with different melting transition.

FIGS. 2A-T show: SEM images, mapping and EDAX of pure LDPE and Sulfur and LDPE-S hybrid composites (2.5, 5, 10, 15, 20 wt. %). (a) Pure LDPE, (b) Sulfur, (c) LDPE-S-2.5, (d) LDPE-S-5, (e) mapping LDPE (carbon), (f) mapping of pure sulfur (g) sulfur mapping of LDPE-S-2.5, (h) sulfur mapping of LDPE-S-5, (i) EDAX spectrum of LDPE, (j) EDAX spectrum of pure sulfur, (k) EDAX spectrum of LDPE-S-2.5, (l) EDAX spectrum of LDPE-S-5, (m) LDPE-S-10, (n) LDPE-S-15, (o) LDPE-S-20, (p) EDAX spectrum of LDPE-S-10, (q) EDAX spectrum of LDPE-S-15, (r) sulfur mapping of LDPE-S-15, (s) sulfur mapping of LDPE-S-20 and (t) EDAX spectrum of LDPE-S-20.

FIGS. 3A-H show Transmission electron micrographs (TEM) of LDPE and LDPE-S materials, according to one or more embodiments of the present disclosure: (A) pure LDPE; (B) pure sulfur; (C) LDPE-S-2.5; (D) LDPE-S-5; (E) LDPE-S-10; (F) LDPE-5-15; (G) LDPE-S-20; and (H) expanded zone of LDPE-S-5. Samples were prepared by ultra-microtome and the slices were placed on a copper grid.

FIGS. 4A-C show (A) Typical tensile stress vs. strain curves for LDPE-S materials, according to one or more embodiments of the present disclosure at room temperature and for a crosshead speed of 10 mm min⁻¹; (B) Ultimate tensile strength and modulus of hybrid composites with respect to different concentration of sulfur loading, according to embodiments of the present disclosure; and (C) Mercury adsorption percentage with respect to time at 40° C. of LDPE-S materials according to one or more embodiments of the present disclosure.

FIGS. 5A-D show (A) CV curve of “LDPE-S-15” (i.e., a hybrid composite according to one or more embodiments of the present disclosure) at various scan rates (5 mVs⁻¹ to 200 mVs⁻¹) in 2M KOH electrolyte; (B) Galvanostatic charge discharge curve of LDPE-S-15 at various current densities; (C) Ragone plot of LDPE-S-15 and (D) operational stability of LDPE-S-15 over 3000 cycles.

FIGS. 6A-D show representative Raman spectra of LDPE, sulfur, and LDPE-S materials according to one or more embodiments of the present disclosure: (A) Full spectrum; (B) Spectral range 100-700 cm⁻¹; (C) spectral range 800-1600 cm⁻¹; and (D) spectral range 2700-3000 cm⁻¹

FIGS. 7A-D show (A) X-ray powder diffraction (XRD) patterns of LDPE, pure sulfur, and LDPE-S materials with sulfur content of 2.5-20% by weight according to one or more embodiments of the present disclosure; (B) Expanded zone of LDPE, pure sulfur, and LDPE-S materials according to one or more embodiments of the present disclosure from 20-30 degree and; (c) and (d) ATIR-FTIR spectra of LDPE and LDPE-S materials according to one or more embodiments of the present disclosure and expanded zone from 2800 cm⁻¹ to 3000 cm⁻¹.

FIGS. 8A-B show (A) TGA curves of LDPE and LDPE-S materials according to one or more embodiments of the present disclosure in the temperature range 25-700° C. at a heating rate 10° C./min and; (B) DTG curves of LDPE and LDPE-S materials according to one or more embodiments of the present in the temperature range 25-700° C. at a heating rate 10° C./min.

### DETAILED DESCRIPTION

Embodiments of the present disclosure feature a hybrid composite material comprising a polymer matrix and elemental sulfur substantially uniformly dispersed in the polymer matrix, wherein the polymer is a branched polymer, as well as electrochemical devices, such as batteries, supercapacitors, etc., which may be fabricated from the hybrid composite material, adsorbents comprising the hybrid composite materials, and methods for preparing the same.

The term “hybrid composite” as used herein refers to a material characterized by a combination of hybrid and composite materials, wherein two or more components, constituents, etc., are dispersed at the nanometer or molecular level in any solid or liquid media. For the purposes of the present invention, the term “liquid” refers to a non-gaseous fluid components, compounds, materials, etc., which may be readily flowable at the temperature of use with little or no tendency to disperse and with a relatively high compressibility.

The term “polymer matrix” refers to a matrix which provides the external or continuous (bulk) phase in which are dispersed the elemental sulfur.

The term “substantially uniformly dispersed” refers to a dispersion of elemental sulfur in the bulk (continuous) phase (e.g., polymer matrix) such that the bulk phase is substantially uniform in terms of composition, texture, characteristics, properties, etc.

The polymer matrix can include any branched polymer, including homopolymers and copolymers. Branched polymers display lower density than linear polymers as a consequence of reduced packing efficiency of the branched chains. In some cases, the density of the branched polymer can be within the range of 0.919-0.925 g/cc, or lower. The length of branched chains differentiates between long- or short-branched polymers. A branched polymer of the present invention can have long branches. In some cases, the branched polymer has a comb-like, random, or a star-shaped structure. In some cases, the polymer matrix does not include a crosslinked polymer.

The polymer matrix can include an ethylene-based branched polymer, e.g., polyethylene (PE). The term “ethylene-based” refers to a polymer that comprises a majority amount of polymerized ethylene based on the weight of the polymer and, optionally, may comprise at least one comonomer. Many kinds of PE are known, with most having the chemical formula (C₂H₄)n. PE is usually a mixture of similar polymers of ethylene, with various values of n. One example of a branched polyethylene polymer is low-density polyethylene (LDPE). The term “LDPE-S” as used herein refers to a hybrid composite material of elemental sulfur in a LDPE polymer matrix. Branched polyethylene can be differentiated from high-density polyethylene (HDPE), which is characterized as a linear polymer. Branched PEs such as LDPE and LLDPE differ from HDPE in branch length and number. For example, LDPE has branches that are both short and long throughout the polymer backbone and LLDPE has only short branches. LLDPE can be further differentiated by density in to very-low and ultra-low density PE (VLDPE and ULDPE). HDPE is considered a linear polymer.

Suitable comonomers for use with ethylene-based branched polymers include, but are not limited to, ethylenically unsaturated monomers, and especially C₃₋₂₀ alpha-olefins, carbon monoxide, vinyl acetate, and C₂₋₆ alkyl acrylates. In one embodiment, the ethylene-based polymer does not contain comonomers capable of crosslinking polymer chains, for instance comonomers containing multiple unsaturations or containing an acetylenic functionality.

In some cases, the branched polymer matrix includes a blend with one or more other polymers, such as, but not limited to, high pressure copolymers and terpolymers, including grafted copolymers and grafted terpolymers; linear low density polyethylene (LLDPE); copolymers of ethylene with one or more alpha-olefins, such as, but not limited to, propylene, butene-1, pentene-1, 4-methylpentene-1, pentene-1, hexene-1 and octene-1. The amount of branched polymer in the blend can vary widely, but typically it is from 5 to 90, or from 10 to 85, or from 15 to 80, wt % percent, based on the weight of the polymers in the blend. The polymers may be blended with other components to serve as polymer matrix, as well as provide functionality, structural integrity, etc., for the desired application (e.g., for structural integrity of an electrode). Although LDPE is shown as an example in this disclosure, one or more of the following in place of LDPE or in combination with LDPE can be utilized: high density polyethylene (HDPE), low-low density polyethylene (LLDPE), ultra high molecular weight polyethylene, and polyethylene, for example.

The hybrid composite material further includes elemental sulfur. The elemental sulfur can be present in particulate form. In some cases, the sulfur particles can be nanosized. For example, the particle size can be within the range of 1-1000 nm, 10-500 nm, or 20-100 nm. The polymer matrix can be designed to not only support good conductivity and dispersion of sulfur, but also, to constrain sulfur within a framework. The elemental sulfur can be substantially uniformly dispersed in the polymer matrix. The hybrid composite material can include any amount of elemental sulfur that does not result in substantial aggregation within the polymer matrix. In some cases, the total content of elemental sulfur is between 0.5 wt % and 50 wt % of the hybrid composite material, such as within the range of 1-30 wt %, 5-25 wt %, 10-20 wt %, and any intervening value (e.g., 2.5, 5, 10, 15, 20 wt. %).

One or more additives may be added to the hybrid composite material. Suitable additives include stabilizers; fillers, such as organic or inorganic particles, including clays, talc, titanium dioxide, zeolites, powdered metals, organic or inorganic fibers, nano-sized particles, clays, and so forth; tackifiers; and oil extenders. A plasticizer can be added to the polymer matrix material to soften, make more flexible, malleable, pliable, plastic, etc., a polymer (e.g., the branched polymer), thus providing flexibility, pliability, durability, etc., which may also decrease the melting and the glass transition temperature of the polymer.

The components of the hybrid composite material may be blended by means of ultrasonic devices, cryogenic crushers, kneaders, extruders, ball milling, high-shear mixers, and the like. For example, elemental sulfur, and optional additive/plasticizer may be blended into the polymer matrix and then extruded using a single- or twin-screw extruder into a filament or pellet form. The skilled artisan is capable of adjusting processing parameters (e.g., the extruder type, screw design/diameter, compression ratio, cylinder temperature, melt temperature, pressure, etc.) based on the properties of the selected branched polymer The blended material can be further processed into a suitable form for the desired application. For example, extruded material such as pellets or filaments can be compression molded to form films or other molded articles or ground into powder.

Another aspect of the present disclosure features a device, component, etc., for storing electrical energy, such as an “electrochemical capacitor” or “supercapacitor”. In one example, the device includes an electrode material comprising the hybrid composite material. Embodiments of the electrochemical device of the present disclosure may be in the form of an electrochemical cell, each electrochemical cell including two half-cells, each half-cell comprising: an electrode; and at least one electrolyte in contact with the electrode in each half-cell. Each electrode comprises: a polymer matrix and elemental sulfur substantially uniformly dispersed in the polymer matrix (for example, in amounts in the range of from about 2.5 to about 40% by weight, such as from about 10 to about 30% by weight, of 15 wt % of the hybrid composite material).

The electrolyte can be any material, substance, composition, etc., which is sufficiently ionized (e.g., due to ionized salts dissolved in a liquid medium (such as water, as well as other solvents such as propylene carbonate, dimethyl sulfoxide (DMSO), dimethyl formamide (DMF), ethylene carbonate, diethyl carbonate, acetonitrile, sulfolane, γ-butyrolactone, etc.) ionized salts present in a gel or solid, etc.) to conduct an electrical current. Electrolytes may exist as liquids, solids, semi-solids (e.g., gels), etc. The electrolyte may include one or more of the following salts: LiClO₄, LiPF₆, LiBF₄, LiCF₃SO₃, LiN(CF₃SO₂)₂, etc., in one or more aprotic solvents. Aqueous solutions of H₂SO₄, H₃PO₄, KOH, etc., may also be employed in some embodiments as well as tetraethylammonium salts such as C₈H₂₀N⁺(PF₆)⁻, C₈H₂₀N⁺(BF₄)⁻, etc., in aprotic solvents. Aprotic solvents suitable for this purpose may include one or more of: propylene carbonate, dimethyl sulfoxide (DMSO), dimethyl formamide (DMF), ethyl cellulose (EC), diethyl carbonate (DEC), CH₃CN, γ-butyrolactone, sulfolane, etc.

An electrode for supercapacitor application can include a dispersion of ground hybrid composite material. In some cases, the dispersion is formed into a paste that further comprises at least one of a binder and conductive filler (e.g., furnace black, thermal black, lamp black, channel black, and acetylene black, or other carbon black). The binder can be any polymer used in the production of composite electrodes, such as PVDF, nafion, and PTFE. The consistency of the paste can be adjusted with additional solvent. The paste can be applied to a metal electrode, such as a metal foam electrode. In some cases, the paste is applied to a nickel (Ni) foam, a titanium (Ti) foam, a manganese (Mn) foam, or a molybdenum (Mo) foam electrode. The metal foam can be in contact with a substrate (e.g., a glass substrate).

Also provided are methods of collecting current using the electrochemical devices of the present disclosure. Embodiments include applying an external electric field to an electrochemical capacitor comprising two electrodes, each electrode comprising a polymer matrix and elemental sulfur substantially uniformly dispersed in the polymer matrix (for example, in amounts in the range of from about 2.5 to about 40% by weight, such as from about 10 to about 30% by weight, of 15 wt % of the hybrid composite material; and an electrolyte in contact with each of the two electrodes; wherein one of the electrodes is the cathode, and wherein the other electrode is the anode.

In another aspect, the present disclosure features an adsorbent composition configured for use as a mercury adsorbent composition. Embodiments of the adsorbent composition of the present disclosure includes a hybrid composite material comprising a polymer matrix and elemental sulfur substantially uniformly dispersed in the polymer matrix, wherein the polymer is a branched polymer. The hybrid composite material can include any amount of elemental sulfur that does not result in substantial aggregation within the polymer matrix. In some cases, the total content of elemental sulfur is between 0.5 wt % and 50 wt % of the hybrid composite material, such as within the range of 1-30 wt %, 5-25 wt %, 10-20 wt %, and any intervening value (e.g., 2.5, 5, 10, 15, 20 wt. %).

Methods of use the adsorbent composition are also described. For example, embodiments include a method for separating mercury from a mercury containing fluid, comprising: (a) providing a mercury adsorbent material comprising hybrid composite material comprising a polymer matrix and elemental sulfur substantially uniformly dispersed in the polymer matrix, wherein the polymer is a branched polymer; and (b) contacting the mercury adsorbent material with a mercury containing fluid. The hybrid composite material can include any amount of elemental sulfur that does not result in substantial aggregation within the polymer matrix. In some cases, the total content of elemental sulfur is between 0.5 wt % and 50 wt % of the hybrid composite material, such as within the range of about 1-30 wt %, about 5-25 wt %, about 10-20 wt %, and any intervening value (e.g., 2.5, 5, 10, 15, 20 wt. %). The mercury adsorbent material can be configured to remove at least 50% of mercury in the fluid within 30 minutes of contact, such as at least about 60%, at least about 65% or at least about 70%. In some cases, the method includes adjusting the temperature of the mercury containing fluid to about 40° C. The mercury containing fluid can be an aqueous fluid. In some cases, the fluid is produced water (e.g., water that is a byproduct of crude oil production). The mercury adsorbent material can be in the form of a molded article, film, pellet, filament, or particle.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

The following Example is intended to illustrate the above invention and should not be construed as to narrow its scope. One skilled in the art will readily recognize that the inventors suggest many other ways in which the invention could be practiced. It should be understood that numerous variations and modifications may be made while remaining within the scope of the invention.

### Example 1: Synthesis of Low-Density Polyethylene (LDPE)/Elemental Sulfur Hybrid Composite (LDPE-S) as Electrode Material

Hybrid composite material properties can be enhanced through the combination of anticipated properties from each material. Addition of fillers in the polymer matrix to improve composite materials properties has been receiving great attention in industry and research. Good dispersion of fillers in the polymer matrix has generated substantial interest in proposing hybrid composite materials for several applications. Inorganic fillers such as silica, ZnO, iron oxide, TiO₂, calcium carbonate, and mica provide excellent thermo-mechanical properties, but it is expensive. Recently a lot of renewable resource filler, clay and fibers are available in high abundance, less expensive and eco-friendly. The hybrid composite material properties depend on the filler chemical structure and particles distribution in the host matrix. Reports describe synthesis and characterization of LDPE-natural clay nanocomposites. LDPE-clay nanocomposites show remarkable improvement in thermo-mechanical properties with respect to pristine polymers. The interfacial interactions and hybrid assembling in LDPE-filler nanocomposite have been described. An Extrusion process was employed to prepare a polyethylene grafted malic anhydride/organic montmorillonite (PE-g-MAH-OMMT) nanocomposite. Instrumental techniques provided information regarding the architecture and nature of the chemical interactions in the nanocomposites. The synthesis and properties of the LDPE-feather hybrid composites have also been reported. FTIR spectroscopy, DSC instruments were used to study the changes in the properties of the LDPE-feather hybrid composites.

Concerning about potential electrical and thermal conductive hybrid materials, composites containing conducting carbon such as graphene, carbon nanotube (CNT) structures have attracted considerable research interest. The conducting carbon materials such as graphene, CNTs possess unique properties. These unique properties make hybrid composite materials suitable for different functional applications. Polymer-graphene hybrid composites have been developed to improve the thermo-mechanical and dispersion properties. The interaction in the hybrid materials was observed as being conferred by π-π stacking, which increased the overall properties of the hybrid materials.

Sulfur is one of the major by-product produced from gas processing and have gained attention. Cost-effectiveness, nonabrasive, high filling levels and mechanical properties, and high abundance can make sulfur as promising fillers in the hybrid composite materials. Previous research has reported the enhancement of properties of hybrid composite materials by introducing fibers, and other fillers. However, the morphology, structural arrangement and mechanical properties of the composites by using sulfur as filler are limited. Crystallinity, thermal, and morphological behaviors of sulfur-based hybrid composites have not been investigated thoroughly.

Moreover, reducing fossil fuel consumption and greenhouse emission is the global issue being recognized as an imperative for the development of sustainable energy storage technology. Nowadays, research has been focused on pollution-free energy sources, typically supercapacitors. Supercapacitor is the hybrid properties of conventional batteries and capacitor about high power density and energy density, fast charge-discharge rates and long cycle life. These unique properties of supercapacitor make it face the energy demands in the field of hybrid energy vehicles, rockets and vehicles for space, memory backup, and portable electronic devices, etc. Supercapacitors can be categorized by energy storage mechanisms: (i) pseudocapacitors and (ii) electrical double layer capacitors (EDLC). An EDLC stores energy by the electrostatic accumulation of charge in the electrical double layer near electrolyte and electrode contact and corresponding electrode materials are usually carbon-based. Pseudocapacitive electrode materials can be further categorized into two types: (1) polymer-based materials such as PEDOT-PSS, polyaniline, polypyrrole, polythiophene and some of their derivatives; and (2) Metal oxides and hydroxides. Compared to the metal oxides/hydroxides-type pseudocapacitive electrode materials, polymer-based materials are promising for the realization of high-performance supercapacitors owing to their good electrical conductivity, environmental stability, low cost and high theoretical specific capacitance. Many polymer-based materials have been explored as supercapacitor electrode materials.

The following example describes synthesis of polymer-based hybrid composites, referred to herein as “LDPE-S”, having LDPE as a polymer matrix with sulfur dispersed as filler. LDPE-S materials were synthesized by twin-screw extrusion technologies and hot pressing to form films. The obtained LDPE-S films were morphologically and structurally assessed using TEM, SEM, XRD, Raman spectroscopy and DSC to elucidate the characteristics of the sulfur in the LDPE matrix, and its effect on the crystalline nature of LDPE. In addition to describing the morphology, thermo-mechanical properties and mercury adsorption analysis of LDPE-S materials, the energy storage performance of LDPE-S was studied to determine its suitability for supercapacitor applications. This example represents the first investigation of LDPE-S for use in supercapacitors.

### RESULTS AND DISCUSSION

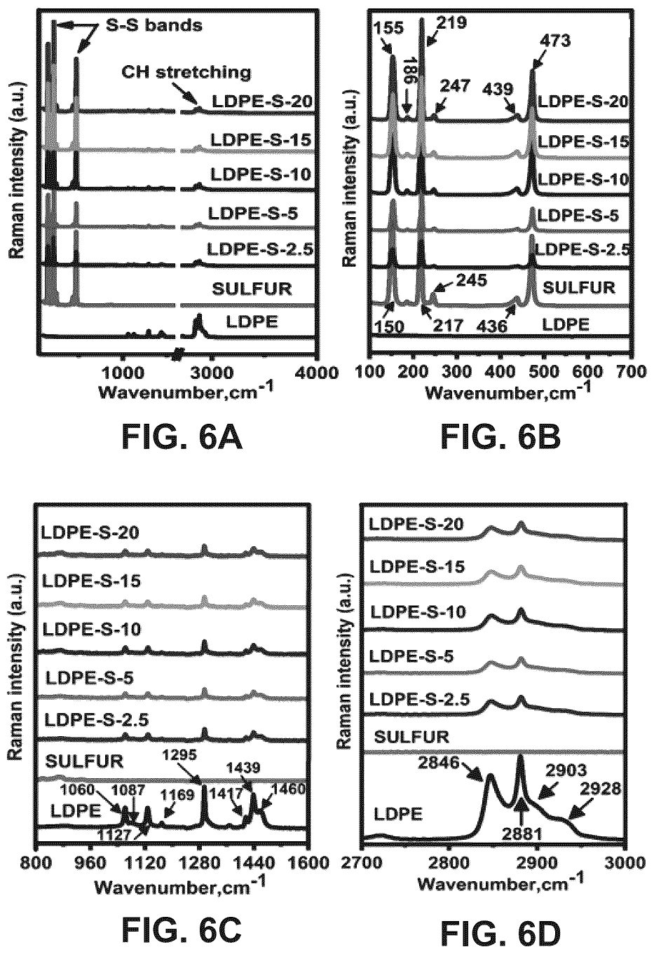

Raman analysis: FIG. 6(A) shows the Raman spectra of sulfur, LDPE and LDPE-S. Sulfur shows a series of characteristic Raman peaks at 150, 184, 217, 245, 436, and 474 cm⁻¹ corresponding to S—S bond (shown in more detail in FIG. 6(B)). Representative sulfur peaks are reduced in intensity when sulfur is embedded in the composites. LDPE exhibits bands at 1460, 1439, 1417, 1397, 1368, 1295 and 1169 cm⁻¹ representing asymmetric δ(CH₃) bending band, asymmetric δ(CH₂) bending band, symmetric δ(CH₂) bending band, symmetric δ(CH₃) bending band, CH₃ wagging, CH₂ twisting and CH₂ rocking (see, FIGS. 6(C) and (D). Raman spectra for pure LDPE and LDPE-S in the band zones (800-1600 cm⁻¹) were enlarged to simplify the detection of amorphous and crystalline phases (FIG. 6(C)). Peaks are observed at 1060 and 1127 cm⁻¹ is due to C—C stretching bond of all-trans-(CH₂)ₙ— and the amorphous phase of LDPE peak is attributed at 1087 cm⁻¹. The carbon (C—C) vibration of polyethylene crystallites peaks are observed at 1125, 1056 and 1079 cm⁻¹ have been reported previously in the literature. Peaks at 1060 and 1127 cm⁻¹ are existing with altered intensities in LDPE-S-2.5 (i.e., LDPE hybrid composites with 2.5 wt % sulfur) and at high sulfur loading (>2.5 wt %), these peaks remain constant without any changes. Without being bound by theory, this observation suggests that the crystalline phase of the polymer was influenced up to 2.5 wt. % of sulfur concentration, but beyond this concentration, sulfur loading has no significant effect. The C—C stretching peak at 1087 cm⁻¹ for the amorphous phase was affected in all composites by loading of sulfur and this band (1087 cm⁻¹) disappeared at higher sulfur concentration, which indicates the uniform and predominate distribution of sulfur particles in the amorphous phase of LDPE.

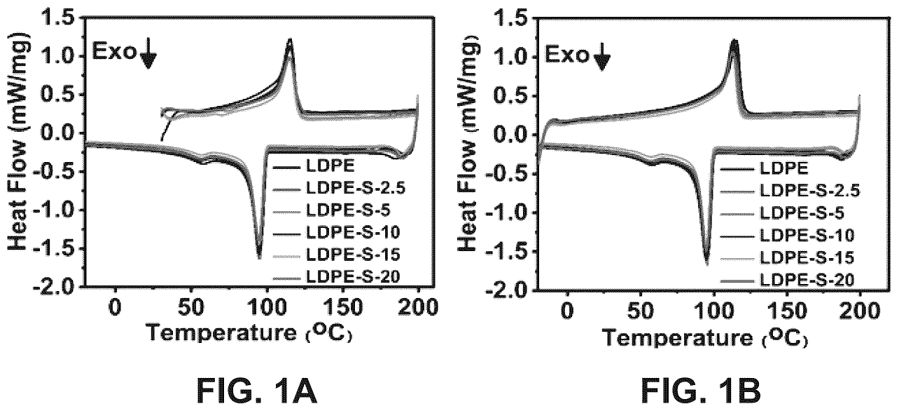

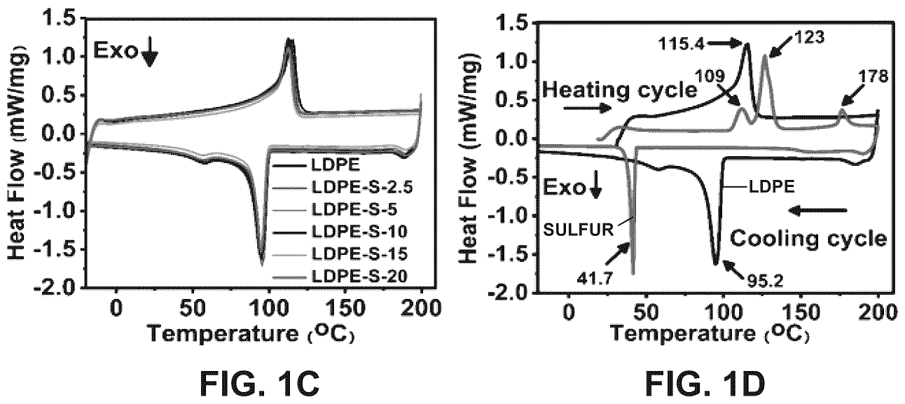

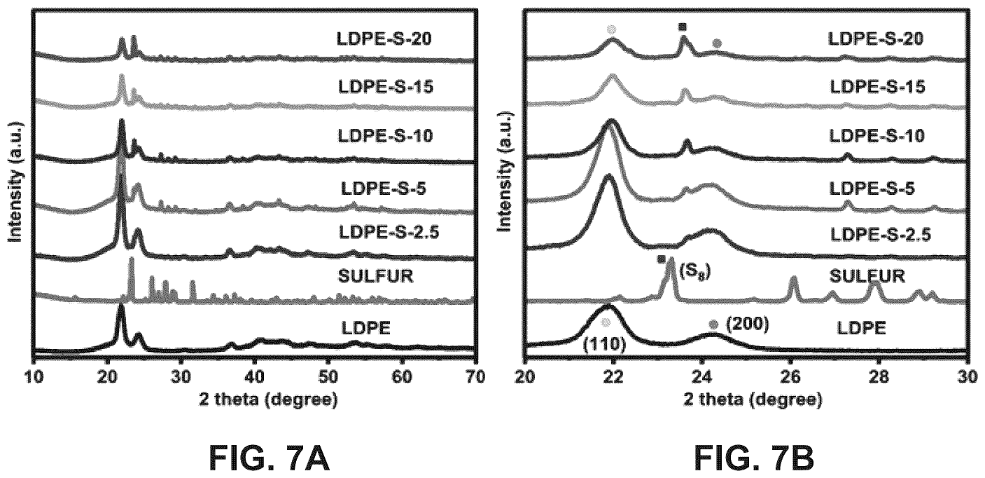

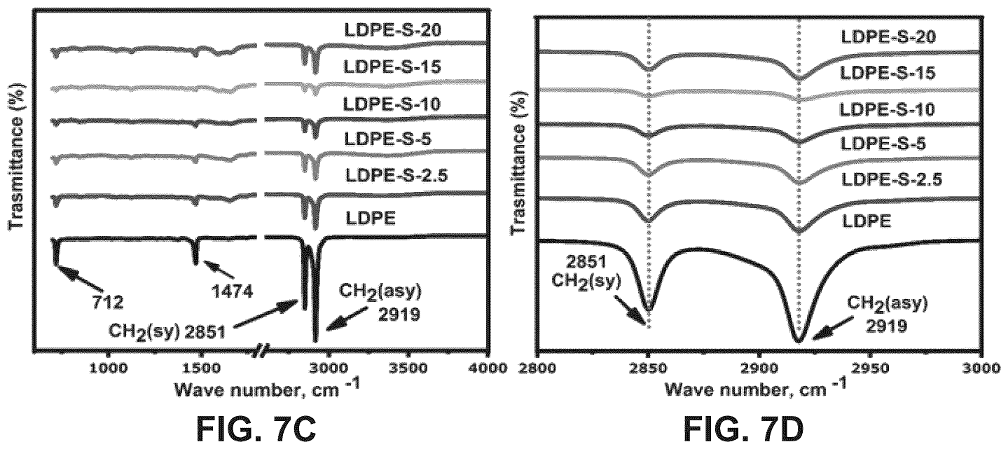

XRD analysis: FIG. 7A shows the XRD patterns of LDPE, Sulfur and LDPE-S with different wt % of sulfur content. The LDPE sample shows characteristic semi-crystalline peaks of the (200) and (110) crystal planes at 24.2° and 21.7° respectively. The presence of these peaks of LDPE caused by the scattering from the polymer chains at the interplanar spacing and hence confirms the semi-crystalline structure. The characteristic diffraction peaks for LDPE are present in all LDPE-S samples. In addition, the presence of diffraction peaks located at 23.2°, 25.9°, 26.8, 27.9°, 28.8° and 31.4° indicates the crystallized orthorhombic sulfur (S₈) structure. No change in the diffraction peak positions of (110) and (200) crystal planes was observed when the sulfur content was increased from 2.5 to 20 wt % (FIG. 7B). This result signifies that increasing the sulfur content has no effect in the intermolecular distance of hybrid composites, and that the sulfur loading on LDPE polymer has no significant influence on the LDPE crystal structure. The Raman and DSC analysis also support the similar observation (FIGS. 1A-D). The LDPE-sulfur composite with higher sulfur-content shows the distinguished crystalline sulfur diffraction peak at 23.2°. The diffraction peak intensity of the crystalline sulfur increased with increasing the sulfur contents in LDPE-sulfur composite.

FTIR analysis: FTIR spectra of the LDPE, Sulfur, and LDPE-S are shown in FIG. 7C. The prominent and characteristic peaks corresponding to —CH₂ₛₜᵣ of LDPE appear at 2919 and 2851 cm⁻¹. The bands noted at 1474 and 712 cm⁻¹ are due to methylene scissoring and rocking vibrations. FTIR spectra of LDPE and LDPE-S towards the CH₂ stretching zone are shown in FIG. 7(D). No significant difference was observed in the spectra, however, the peak intensity for LDPE-S is not identical in shape. This result suggests that the hybrid composite materials may not have exactly the same structure and absorb IR radiation differently. Without being bound by theory, this result may be attributable to the physical influence of sulfur in the polymer chain.

DSC analysis: The DSC thermograms of first, second and third heating and cooling cycles for LDPE-S materials with different sulfur contents are shown in FIGS. 1(A-C). FIG. 1(D) shows the DSC analysis of LDPE and sulfur for comparison. The melting temperature of the LDPE was around 115.6° C. while the elemental sulfur showed three different transitions around 95, 123, and 165° C. The experimental and calculated enthalpies of LDPE and the composites including the melting point (Tₘ), enthalpy of melting (ΔHₘ) and crystallinity (% X_{c}) are summarized in Tables 1-3.

TABLE 1
DSC results of LDPE and LDPE-S materials at 1st heating and cooling cycle.

| | | ΔH_{Melt.} | ΔH_{Melt.} | | | | |
|---|---|---|---|---|---|---|---|
| | Tm | (J · g⁻¹) | (J · g⁻¹) | T_{C} | ΔHcryt | Crystallinity | Crystallinity |
| Sample | (° C.) | (Exp) | (calc) | (° C.) | (J · g⁻¹) | (%) (Exp) | (%) (Cal) |
| LDPE | 115.4 | 63.5 | 63.5 | 95.2 | 69.0 | 21.63 | 21.63 |
| LDPE-S- | 114.1 | 61.61 | 61.9 | 95.7 | 69.8 | 21.52 | 21.62 |
| 2.5% | | | | | | | |
| LDPE-S- | 113.8 | 59.94 | 60.32 | 95.4 | 62.38 | 22 | 21.62 |
| 5% | | | | | | | |
| LDPE-S- | 113.5 | 56.36 | 57.15 | 94.8 | 59.1 | 21.33 | 21.63 |
| 10% | | | | | | | |
| LDPE-S- | 112.9 | 53.21 | 53.97 | 94.5 | 54.9 | 21.32 | 21.62 |
| 15% | | | | | | | |
| LDPE-S- | 112.5 | 51.11 | 50.8 | 94.3 | 52.3 | 21.76 | 21.63 |
| 20% | | | | | | | |

TABLE 2
DSC results of LDPE and LDPE-S materials at 2nd heating and cooling cycle.

| | | ΔH_{Melt.} | ΔH_{Melt.} | | | | |
|---|---|---|---|---|---|---|---|
| | Tm | (J · g⁻¹) | (J · g⁻¹) | T_{C} | ΔHcryt. | Crystallinity | Crystallinity |
| Sample | (° C.) | (Exp) | (calc) | (° C.) | (J · g⁻¹) | (%) (Exp) | (%) (Cal) |
| LDPE | 115.34 | 63.3 | 63.3 | 95.1 | 68.9 | 21.55 | 21.55 |
| LDPE-S- | 114.0 | 61.32 | 61.71 | 95.5 | 69.6 | 21.42 | 21.557 |
| 2.5% | | | | | | | |
| LDPE-S- | 113.7 | 59.44 | 60.13 | 95.3 | 62.3 | 21.31 | 21.56 |
| 5% | | | | | | | |
| LDPE-S- | 113.6 | 56.06 | 56.97 | 94.5 | 59.0 | 21.21 | 21.56 |
| 10% | | | | | | | |
| LDPE-S- | 112.1 | 53.14 | 53.8 | 94.7 | 54.5 | 21.29 | 21.558 |
| 15% | | | | | | | |
| LDPE-S- | 111.9 | 51.01 | 50.64 | 94.1 | 52.1 | 21.7 | 21.559 |
| 20% | | | | | | | |

TABLE 3
DSC results of LDPE and LDPE-S materials at 3rd heating and cooling cycle.

| | | ΔH_{Melt.} | ΔH_{Melt.} | | | | |
|---|---|---|---|---|---|---|---|
| | Tm | (J · g⁻¹) | (J · g⁻¹) | T_{C} | ΔHcryt. | Crystallinity | Crystallinity |
| Sample | (° C.) | (Exp) | (calc) | (° C.) | (J · g⁻¹) | (%) (Exp) | (%) (Cal) |
| LDPE | 115.25 | 62.9 | 62.9 | 94.6 | 68.8 | 21.42 | 21.421 |
| LDPE-S- | 113.7 | 61.11 | 61.32 | 95.3 | 68.23 | 21.34 | 21.422 |
| 2.5% | | | | | | | |
| LDPE-S- | 112.8 | 59.14 | 59.75 | 94.84 | 62.11 | 21.20 | 21.423 |
| 5% | | | | | | | |
| LDPE-S- | 113.1 | 56.06 | 56.61 | 94.72 | 58.7 | 21.21 | 21.423 |
| 10% | | | | | | | |
| LDPE-S- | 112.2 | 53.20 | 53.46 | 94.15 | 54.1 | 21.31 | 21.421 |
| 15% | | | | | | | |
| LDPE-S- | 111.4 | 51.13 | 50.32 | 93.83 | 52.2 | 21.76 | 21.423 |
| 20% | | | | | | | |

The DSC thermograms of all the composites show single melting phase transition that implies a higher compatibility between the elemental sulfur and LDPE polymers. The Tm, ΔHₘ and % X_{c} values of LDPE was estimated to be 115.6° C., 63.5 J/g and 21.63%, respectively. No significant change in the Tₘ value of LDPE and LDPE-S materials with different wt % sulfur was observed. The ΔHₘ values of the composites decreases with the increasing in sulfur content, however. This observation may be caused by the relative decrease in amount of LDPE in the composites with increasing sulfur content. The measured melting enthalpy (ΔHₘexp) values were compared with the calculated values (ΔHₘcal) of all the composites. The ΔHₘcal values were determined from ΔHₘ of LDPE and the weight fractions of LDPE in the respective LDPE-S composites. The introduction of sulfur in LDPE has no significant effect on the ΔHₘ of the composites. The experimental and calculated ΔHₘ are within experimental error, indicating that the sulfur content has no influence on the crystal structure of LDPE. The lower crystallinity level for LDPE-S composites suggests improvement in the compatibility between LDPE matrix and elemental sulfur. These results support the conclusion that the sulfur contents have no influence on the crystal structure of the LDPE, and suggest that sulfur plays a role in the amorphous region of the polymer. Additionally, the presence of LDPE suppressed the ability of sulfur to melt and crystalize under these conditions.

Different behavior was observed in the case of HDPE/sulfur composites (reported elsewhere). In the HDPE composites, sulfur melting transitions were not observed despite the overlap of the sulfur and the HDPE melting transitions. All the HDPE/sulfur composites are reported as showing a single transition in heating and cooling cycles and the value of Tₘ, ΔHₘ, T_{c} and ΔH_{c} decreased on addition of sulfur. In the present study, however, the incorporation of sulfur in LDPE has no significant effect on ΔHₘ and T_{c} of the LDPE-S materials. As can be observed from FIG. 1(A-C), the increased thermal cycle does not shift the Tₘ and T_{c} for LDPE and LDPE-S to lower temperature. These observations indicate that the sulfur content is a driving force of

| | | | | | | | Residue | |
|---|---|---|---|---|---|---|---|---|
| | | | | | | | wt. % at | |
| | | | | | | | 300° | 500° |
| Sample Name | T_{1On} | T_{1end} | T₁ₘₐₓ | T_{2On} | T_{2end} | T₂ₘₐₓ | C. | C. |
| LDPE | — | — | — | 449.4 | 492.2 | 480.8 | 99.8 | 0.99 |
| LDPE-S-5% | 197.9 | 287 | 219 | 450.2 | 490.7 | 481.2 | 95.72 | 1.01 |
| LDPE-S-10% | 202.3 | 289.5 | 230.4 | 454.8 | 491.8 | 483.3 | 91.88 | 1.28 |
| LDPE-S-15% | 208.5 | 300.3 | 245.7 | 456.3 | 495.1 | 484.7 | 86.32 | 1.31 |
| LDPE-S-20% | 209.4 | 301.4 | 287.7 | 458.6 | 496.2 | 486.0 | 82.74 | 2.41 |

crystallization and maintains the stability of crystal domains of the LDPE.

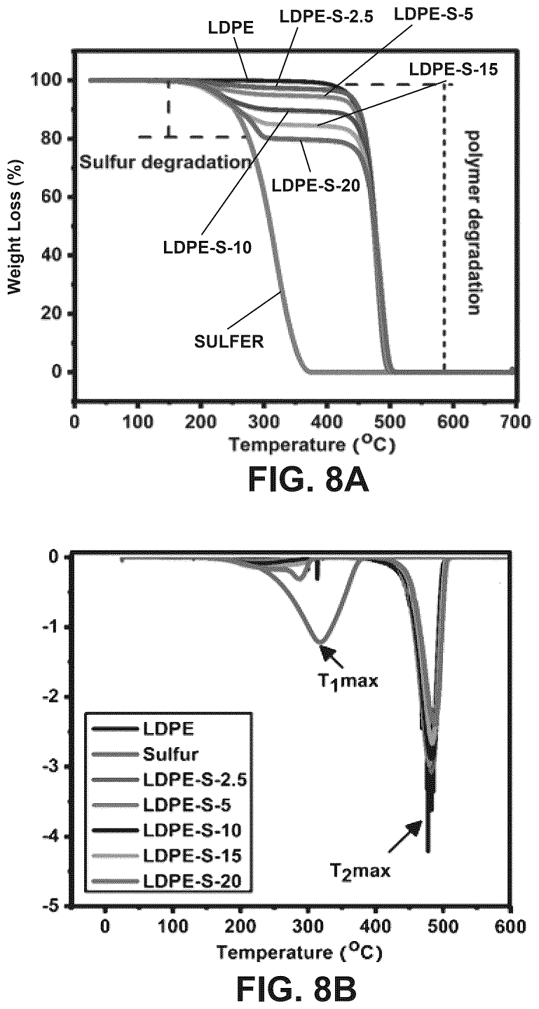

TGA analysis: The thermal stability results of the LDPE-S materials are presented in FIG. 8A. The LDPE exhibits an onset of thermal degradation at 449° C. while the LDPE-S materials show an increase in the thermal degradation temperature. The LDPE-S materials show two-step decomposition profile but LDPE shows the one-step degradation profile (FIG. 8C) The first step was observed between 200 to 300° C. and the second step was observed between 450-500° C. The characteristics thermal decomposition temperature such as onset and endset decomposition temperature (Tₒₙ and T_{end}) and maximum weight loss temperature (Tₘₐₓ) for all the samples were evaluated and summarized in Table 4.

TABLE 4
TGA data of LDPE, and LDPE-S hybrid composites.

[symbol]

[symbol]

indicates data missing or illegible when filed

The onset of first degradation step was improved for LDPE-S materials with increasing the sulfur content. The increase in thermal stability of sulfur degradation step for LDPE-S materials might be due to the protection of sulfur in the amorphous phase of the thermally stable LDPE. The increasing trend in the values of Tₒₙ, Tₘₐₓ and T_{end} for LDPE-S-5%, LDPE-S-10%, LDPE-S-15%, and LDPE-S-20% strongly suggest increased thermal stability. Without being bound by theory, the increase of the thermal degradation temperature of the LDPE-S materials might be attributed due to the homogenous structural arrangement in the amorphous zone of the LDPE polymer.

### Morphology Analysis of LDPE-Sulfur Composites.

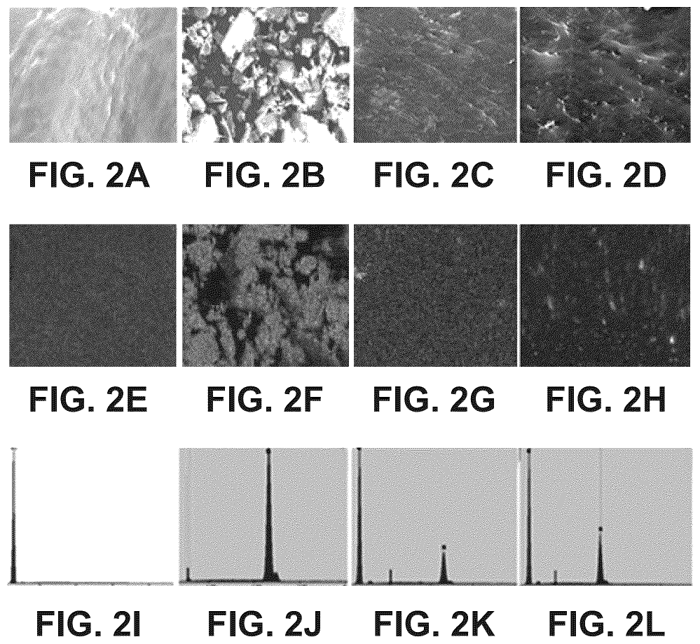

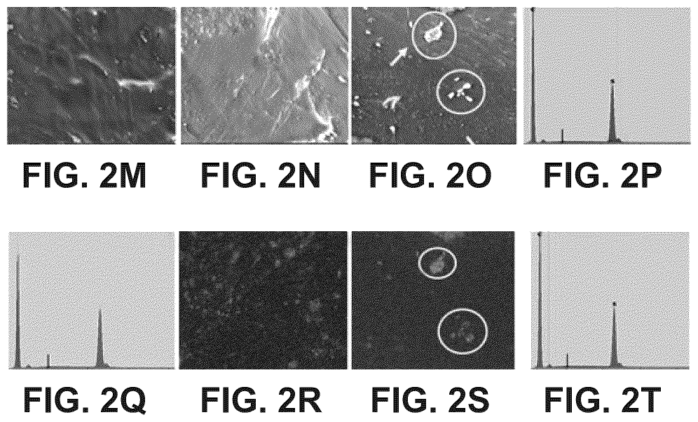

a. SEM analysis. FIG. 2 shows the SEM micrographs, mapping and EDAX of the pure sulfur, LDPE, and LDPE-S materials. The LDPE sample exhibits a typical smooth structure (FIG. 2A). Interestingly, the presence of the sulfur induces the apparent change of the morphology in the LDPE polymer (FIG. 2C, D, M, N, and O). Sulfur aggregates in the higher sulfur content composite (FIG. 2B). This is clearly observed in the mapping of composites. However, the samples up to 15% sulfur content show a smooth and uniform surface morphology and closely interlinked interfaces, such that the hybrid composites at higher content of sulfur show many defects and rough morphology (FIGS. 2C and 2D).

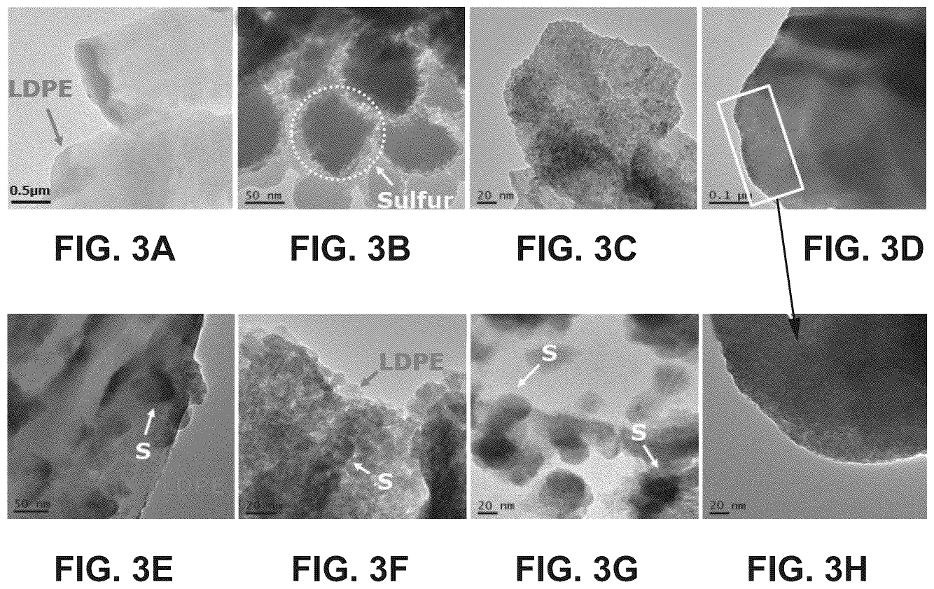

b. TEM analysis. Further, the morphology and sulfur nanoparticles distribution in the LDPE-S hybrid composite was evaluated by TEM analysis. FIGS. 3A-F show TEM images of LDPE, sulfur, LDPE-S-5%, LDPE-S-10%, LDPE-S-15% and LDPE-S-20%, respectively. Sulfur particles are visible as black spots with translucent parts being LDPE polymer matrix. The nanometer level dispersion of sulfur (black particles) was observed in all the LDPE-S materials (See, e.g., higher magnification images FIG. 3G-H). The diameter of sulfur particles was estimated to be in the range of 20-100 nm. Without being bound by theory, better dispersion of sulfur might have resulted from the increased polymerization of the eight ring orthorhombic structure and increased compatibility with polymer network. The compatibility between LDPE and sulfur is responsible for achieving uniform composite. The complete study of the TEM analysis suggests that the aggregation of the sulfur particles is noticeable in high sulfur loading composite, whereas the sulfur particles appear well distributed in the lower concentration materials.

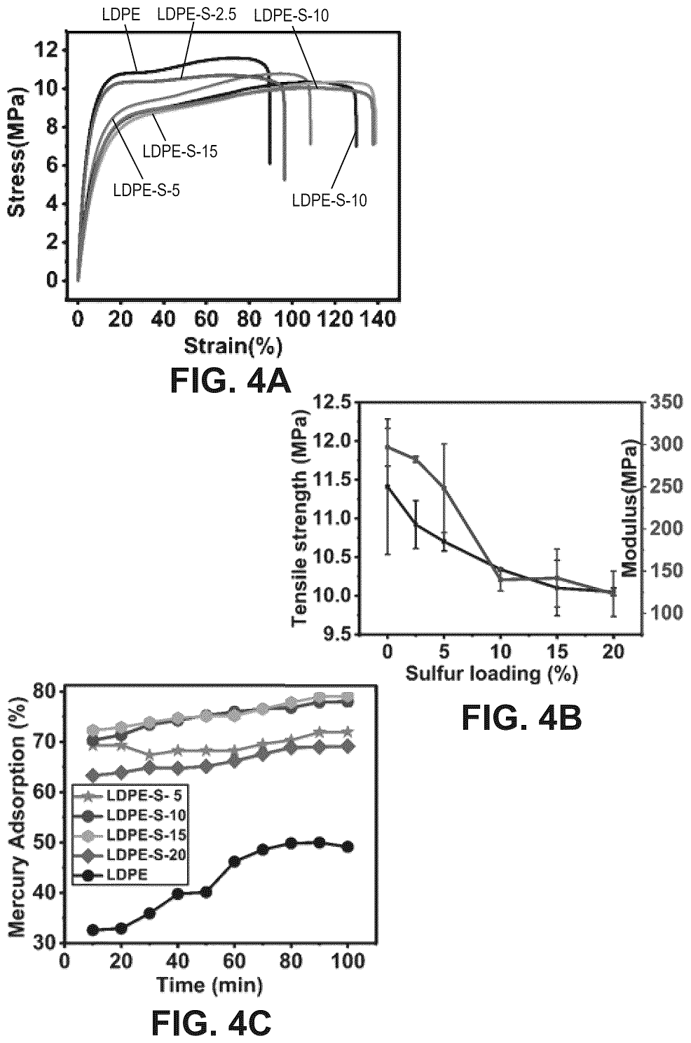

Mechanical Properties: The mechanical properties of LDPE-S materials at different concentration of sulfur were studied by UTM analysis. FIG. 4A shows the stress-strain curves of the hybrid composites. The tensile properties the materials were evaluated for all the materials and summarized in Table 5.

TABLE 5
Mechanical properties of LDPE and LDPE-S materials.

| | UTS | | Elongation |
|---|---|---|---|
| Sample Name | (MPa) | Modulus(MPa) | (%) |
| LDPE | 11.41 ± 0.87 | 296.9 ± 22.32 | 85.98 ± 4.27 |
| LDPE-S-2.5% | 10.92 ± 0.31 | 282.5 ± 3.53 | 89.93 ± 9.17 |
| LDPE-S-5% | 10.70 ± 0.12 | 248.3 ± 52.50 | 106.28 ± 3.18 |
| LDPE-S-10% | 10.34 ± 0.01 | 139.7 ± 13.18 | 121.97 ± 11.14 |
| LDPE-S-15% | 10.10 ± 0.36 | 141.8 ± 34.33 | 136.29 ± 3.66 |
| LDPE-S-20% | 10.05 ± 0.05 | 123.1 ± 26.99 | 132.79 ± 4.54 |

The LDPE sample exhibited a tensile strength of 11.41 MPa, young modulus of around 296.9 MPa and elongation at break percentage of around 85%, respectively. The variation in the ultimate tensile strength (UTS) and Young's modulus of LDPE-S hybrid composites with different sulfur loading percentage is shown in FIG. 4B. The Young's modulus of the composites decreases with the sulfur concentration and attains a minimum value of 123 MPa for LDPE-S-20%. The decrease in Young's Modulus of LDPE with increasing sulfur percentages arises because of lower stiffness of sulfur particles and surface defects. When a surface defect appears, the strain energy was released in the material volume adjacent to the defect. Thus, a reduced strength resulted upon increasing the content of sulfur. Generally, the appearance of defects are important factors for materials strength, however, the reinforcement with sulfur showed a synergistic effect on the elongation with the composites having a higher value than LDPE-nearly 60% more than the strain of the pure LDPE. Elongating force was taken by reinforcing sulfur and the friction between sulfur helped in postponing the failure, during tensile testing. Therefore, all the composites followed higher strain as compared to pure LDPE in the tensile testing conditions.

Mercury adsorption study: Hydrocarbons, water, and non-hydrocarbon atoms are predominantly present in crude oil and natural gas, and they also contain elements or compounds such as arsenic, lead, nickel, vanadium, and mercury at low levels. The presence of mercury in crude oil and natural gas is an essential industrial problem. Therefore, in this work, we examined the LDPE-S materials utility for non-regenerative adsorbent applications. Specifically, the capacity of LDPE-S to remove mercury in aqueous phase was assessed. To study the effect of sulfur concentration on the mercury adsorption, LDPE-S materials with different sulfur concentration (2.5 wt %, 5 wt %, 10 wt %, 15 wt % and 20 wt %) were fabricated for a lab scale experiment. The mercury adsorption results of the composites are shown in FIG. 4C. The mercury adsorption percentage was enhanced significantly after sulfur loading in the LDPE matrix. In LDPE-S materials, around 60-70% mercury was adsorbed at 40° C., while the pure LDPE samples were achieved 30-50% under the same condition. Additionally, the efficiency of mercury adsorption increased with the sulfur loading value up to 15 wt %, but started to decrease considerably at 20 wt % sulfur loading. This may be observed due to the uniform distribution of sulfur nanoparticles in the LDPE polymer matrix. This shows that 15 wt % sulfur loading was the ideal percentage for proper dispersion of sulfur inside the polymer matrix to adsorb mercury under room temperature. However, at higher percentage of sulfur loading leads to the aggregation of the sulfur particles in the composites, hence the adsorption ability decreases. As shown in the SEM and TEM image analysis (see, FIGS. 2 and 3) sulfur nanoparticles are well distributed in the LDPE polymer matrix, which might favor Hg²⁺ removal. The uniform distribution of sulfur may be more critical for an effective adsorbent, than percentage of sulfur loaded (e.g., embedded or impregnated) in the LDPE matrix. The mechanism of mercury removal by LDPE-S materials could be due to the adsorption and catalytic oxidation.

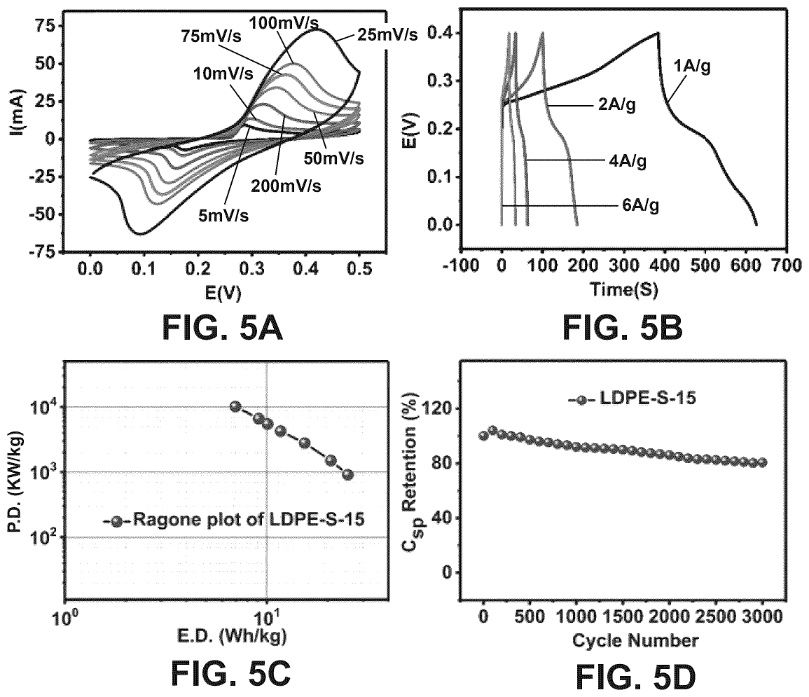

Supercapacitor study: Inspired by the interesting properties of the LDPE-S-15 hybrid composite, the electrochemical performance of LDPE-S material for supercapacitor was explored. The cyclic voltammetry technique was employed in three electrode system at a potential window of 0 to 0.5V in 2M KOH electrolyte. From the CV measurements, the specific capacitance of LDPE-S-15 was calculated by using the following formula.

$${C}_{sP} = {\int }_{E 1}^{E 2} iE ( dE ) / ( {E}_{2} - {E}_{1} ) mv \qquad ( 1 )$$

Where iE(dE) is the area under the curve, (E₂-E₁) is the potential window taken, m is mass of electrode material and υ is the scan rate. The CV curve of LDPE-S-15 at different scan rates is presented in FIG. 5A. The material exhibits a pair of redox peaks that are associated with the electron transfer reactions in alkaline electrolyte. From CV measurements, the Cₛₚ was estimated to be 726 F/g at a scan rate of 5 mVs⁻¹. At higher scan rates, the contribution of pseudocapacitance to the total capacitance restricts due to slow faradic process, which decreases the specific capacitance of the material.

The galvanostatic charge-discharge techniques (CD) were carried out by applying different current densities to support the CV data. The CD curve of LDPE-S-15 is presented in FIG. 5B. From the CD techniques, the specific capacitance was calculated using the follow equation.

$${C}_{sP} = \frac{It}{m ( E 2 - E 1 )} \qquad ( 2 )$$

Where, m is mass of electrode material and t is the discharge time, (E₂-E₁) is the potential window taken at constant current ‘I’. From the CD data, the LDPE-S-15 possesses 601.35 F/g at a current density of 1 Ag⁻¹.

Furthermore, the energy density and power density performance are calculated from the specific capacitance values of LDPE-S-15. The specific energy and power density were calculated by the following equation.

$$Energy density ( E ) = 1 / 2 Csp {( Δ V )}^{2} \qquad ( 3 )$$

$$Power Density ( P ) = E / T \qquad ( 4 )$$

Where Csp is specific capacitance, ΔV is the potential window in Volt; T is the discharge time of the CD curve. The Ragone plots of E.D. Vs. P.D. is also presented at different scan rate in FIG. 5C. From this plot, the E.D. and P.D. values of the LDPE-S-15 were found to be 25.20 Wh/kg and 907.5 KW/kg, respectively.

A comparison of the present supercapacitance properties of LDPE-S-15 with the reported literature on polymer-based materials is summarized in Table 6. The performance was observed to be favourably comparable to reported properties, further supporting its use in energy storage applications needed for a supercapacitor.

TABLE 6
Supercapacitance properties of LDPE-S-15 material (i.e.,
LDPE-S with 15 wt % sulfur content) compared polymer-
based materials reported in the literature.

| | | | | Capacitance |
|---|---|---|---|---|
| | Materials | Electrolyte | System | and cycle life |
| Published | PANI | 2MH₂SO₄ | Three | 215 F/g at |
| reports | nanowire | | electrode | 0.1 A/g |
| | | | system | 69% over |
| | | | | 1000 cycle |
| | PANI | 1MH₂SO₄ | Two | 554 F/g at |
| | nanofibre | | electrode | 1 A/g |
| | | | system | |
| | Cross linked | 1MH₂SO₄ | Three | 601 F/g at |
| | PANI net | | electrode | 0.5 A/g |
| | | | system | 80.8% at |
| | | | | 2 A/g |
| | | | | 1000 cycle |
| | polypyrrole | 1MKCL | Three | 285 F/g at |
| | | | electrode | 1 A/g |
| | | | system | 68.9% over |
| | | | | 500 cycle |
| | Polypyrrole | 1M Na₂SO₄ | Three | 420 F/g at |
| | nanowire | | electrode | 1.5 A/g |
| | | | system | |
| | Polypyrrole | 1M H₂SO₄ | Two | 122 F/g at |
| | Nanosphere | | electrode | 1 A/g |
| | | | system | 62.83% OVER |
| | | | | 3000 CYCLES |
| | Flexible | PVA + H₃PO₄ | Two | 448 mFcm⁻² at |
| | PEDOT-PSS | | electrode | 10 mV/s |
| | film | | system | |
| | PEDOT-PSS | 1M Na₂SO₄ | Three | 106.3 F/g at |
| | film | | electrode | 500 mA/cm² |
| | | | system | 74.5% over |
| | | | | 1000 cycle |
| | polythiophene | 1M Net₄⁺, | Two | 260 F/g at |
| | | CF₃SO₃⁻ in | electrode | 2.5 mAcm⁻² |
| | | acetonitrile | system | |
| Present | LDPE-S-15 | 2M KOH | Three | 601 F/g at |
| disclosure | | | electrode | 1 A/g |
| | | | system | 80.5% over |
| | | | | 3000 cycles |

The cycle life of the electrode material is an important factor in a supercapacitor. The operational stability of LDPE-S-15 sample was tested by performing multiple charge-discharge cycles at a current density of 2 A/g (FIG. 5D). The material exhibited a stability of about 80.5% over 3000 cycles.

### CONCLUSIONS

Elemental sulfur filled hybrid composites based on LDPE having varying sulfur concentrations were prepared via a one-step extrusion method. Increases in sulfur loading resulted in similar melting transition within experimental error. The DSC data demonstrated that the sulfur loading did not induce crystallization of LDPE during the extrusion process. The XRD and DSC results revealed that the sulfur molecules do not significantly affect the crystal structure of the LDPE. The negligible difference in melting, crystallization temperature in composite systems compared to neat LDPE supports a conclusion that sulfur plays an active role in the amorphous region of LDPE. SEM and TEM analysis demonstrated that sulfur particles were homogeneously dispersed in the LDPE matrix. The TGA measurement revealed an enhancement of the thermal stability of the composites with increasing sulfur content. The TGA results revealed that the introduction of sulfur does not improve the onset degradation temperature value of LDPE. The sulfur in the amorphous regions may be responsible for the relatively higher thermal stability of LDPE-S materials as compared with pure LDPE. The LDPE-S materials showed enhanced mechanical properties in comparison to pure LDPE polymer. Interestingly, there was a significant effect of the sulfur on elongation percentage of the composites. The LDPE-S-15 hybrid composite showed better mercury adsorption property than other hybrid composites. Also, the mercury adsorption of LDPE-sulfur hybrid composites was found to be enhanced significantly with increasing sulfur concentration and saturated beyond 15% of loading. The interesting structure and properties of LDPE-S-15 hybrid composite appealed to explore the energy storage applications towards supercapacitor. The LDPE-S-15 hybrid composite showed comparable pseudocapacitance of 726 F g⁻¹, the power density of 907.5 KW/kg, the energy density of 25.2 Wh/kg, with long-term operational durability. This observation supports the worth of LDPE-S-15 hybrid composite as new and promising energy storage materials of interest.

### EXPERIMENTAL

Materials: Low-density polyethylene (LDPE) was obtained from ALDRICH, USA. Before composite preparation, LDPE pellets were dried at 80° C. for 4 h in an oven. Elemental Sulfur (granulated) was supplied by Abu Dhabi Gas Industries Limited (GASCO, Abu Dhabi, United Arab Emirates) and used as received without further purification. Mercuric Chloride (98% pure) was supplied by Sigma Aldrich Co, UAE.

Hybrid Composite Preparation: LDPE was used as the polymer matrix and elemental sulfur (2.5-20% by weight) was used as filler to synthesize the LDPE-Sulfur hybrid composites (LDPE-S). LDPE-S materials were prepared by a twin-screw extruder at 100 rpm screw speed at 180° C. for 15 min. The composites were collected and cut into small pellets. Finally, pellets were compression molded in the hot press for 10 minutes at 170° C. Composites with the size of 5 mm×150 mm×200 mm were formed.

Characterization techniques: Raman spectra were obtained on a Jobin Yvon Horiba LabRAM spectrometer with the back-scattered confocal configuration using a HeNe laser (633 nm). A long working distance objective with magnification 50× was used both to collect the scattered light and to focus the laser beam on the sample surface. CCD (charge-coupled device) detector exposure time was 5 s and an average of 1 cycle was used to increase S/N ratio. Raman shifts were calibrated using Si wafer at 520.7 cm⁻¹. XRD patterns were collected using analytical X'Pert PRO Powder Diffractometer (Cu-Ka radiation 1.5406 A°, 40 kV, 40 mA) in the range of 5°-80° (2θ), with a step size of 0.02°. ATR-FTIR spectra of the LDPE and LDPE-sulfur composites were recorded by Attenuated Totally Reflectance Fourier Transformed Infrared spectroscopy technique, using a Bruker Vertex 70. DSC analysis was performed in Shimadzu DSC-60 using 10° C./min heating rate under nitrogen with 20 mL/min flow rate, from room temperature to 200° C. The percentage of crystallinity was calculated from the melting enthalpy (ΔHm) using the following formula: the enthalpy of 100% crystalline LDPE (ΔHm°) is 293.6 J·g⁻¹ and is used as a reference.

$$\% Crystallinity = 100 \times ( Δ Hm / Δ Hm° F )$$

Where, ΔHm polymer=polymer enthalpy of fusion as in the thermogram, in J·g⁻¹; ΔHm° enthalpy of fusion of LDPE, 100% crystalline, correspondent to 293.6 J·g⁻¹ or 70.125 cal/g. Factor F denotes the fraction of polymer present in the composite. Thermogravimetric analysis (TGA) of the materials was carried out in a Shimadzu TGA-50 thermal analyzer using heating rate of 10° C./min under nitrogen with 20 mL/min flow rate, from room temperature to 700° C. The surface morphology of composites was characterized by SEM (Quanta-FEG-250) and TEM. The materials were characterized by TEM using a FEI Tecnai G2 with a LaB6 filament operated at 200 kV. Samples were prepared by ultramicrotomy and the slices were placed on a copper grid. The mechanical characteristics of the LDPE-S materials were investigated using an Instron 5900 with the Dog-bone shape film specimens. The crosshead speed was maintained at 10 mm/min by ASTM D-683 and three different specimens were tested for each type of LDPE-S composite. The concentration of mercurous chloride (HgCl₂) in the aqueous phase was measured using automatic mercury analyzer (DMA-80).

Electrode Preparation: LDPE-S-15 samples were used to prepare an electrode for supercapacitor application. Initially, the LDPE-S sample was cut into small pieces and prepared powder by grinding. This powder was dispersed in toluene+Xylene (50%+50%), and stirred for 24 h to get clear solution. The working electrode was prepared by utilizing LDPE-S-15 sample (80%) with carbon black (10%) and PVDF as a binder (10%) material mixed with NMP solvent and makes the good slurry. Then, it was pasted on Ni foam (0.5 cm×0.5 cm) electrode and allowed it to dry at 80° C. in a vacuum oven overnight to remove the solvent. Then the Ni foam electrode was pressed at 15 MPa to enhance the contact between the electrode materials with the substrate. The 2M KOH was used as the electrolyte. The cyclic voltammetry and galvanostatic charge-discharge techniques were performed on an electrochemical workstation (Biologic Science, VSP-300).

Electrochemical study: The electrochemical study of LDPE-S towards the supercapacitor application was carried out using the cyclic voltammetry and charge-discharge techniques by a two-compartment three-electrode system. The LDPE-S on Ni foam was used as a working electrode, Pt wire as a counter electrode and Ag/AgCl as a reference electrode.

Various examples have been described. These and other examples are within the scope of the following claims. Other embodiments of the present disclosure are possible. Although the description above contains much specificity, these should not be construed as limiting the scope of the disclosure, but as merely providing illustrations of some of the presently preferred embodiments of this disclosure. Various combinations or sub-combinations of the specific features and aspects of the embodiments may be made and still fall within the scope of this disclosure. Various features and aspects of the disclosed embodiments can be combined with or substituted for one another in order to form various embodiments. Thus, the present disclosure should not be limited by the embodiments expressly described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

1. A method for separating mercury from a fluid, comprising:
contacting a mercury adsorbent material with a mercury-containing fluid, wherein the mercury adsorbent material includes a polymer matrix and elemental sulfur substantially uniformly dispersed in the polymer matrix, wherein the polymer matrix includes a branched polymer.

2. The method of claim 1, wherein the branched polymer includes an ethylene-based branched polymer.

3. The method of claim 1, wherein the branched polymer includes low-density polyethylene (LDPE) homopolymer.

4. The method of claim 1, wherein a weight percentage of the elemental sulfur in the mercury adsorbent material ranges from about 1 wt. % to about 30 wt. %.

5. The method of claim 4, wherein the weight percentage of the elemental sulfur in the mercury adsorbent material ranges from about 5 wt. % to about 25 wt. %.

6. The method of claim 4, wherein the weight percentage of the elemental sulfur in the mercury adsorbent material ranges from about 10 wt. % to about 20 wt. %.

7. The method of claim 1, wherein the elemental sulfur is present as particles having a particle size ranging from 10 nm to 500 nm.

8. The method of claim 1, wherein the elemental sulfur is present as particles having a particle size ranging from 20 nm to 100 nm.

9. The method of claim 1, further including adjusting a temperature of the mercury-containing fluid to about 40° C.

10. The method of claim 1, wherein the mercury-containing fluid includes an aqueous fluid.

11. The method of claim 1, wherein the mercury adsorbent material is configured to remove at least 50% of the mercury in the mercury-containing fluid when contacted with the mercury-containing fluid for 30 minutes.

12. The method of claim 1, wherein the mercury-containing fluid is a byproduct of crude oil production.

13. A method for separating mercury from a fluid, comprising:
contacting a mercury adsorbent material with a mercury-containing fluid, wherein the mercury adsorbent material includes a polymer matrix and elemental sulfur substantially uniformly dispersed in the polymer matrix,
wherein the polymer matrix includes low-density polyethylene, and wherein a weight percentage of elemental sulfur in the mercury adsorbent material ranges from about 1 wt. % to about 30 wt. %.

14. The method of claim 13, wherein the mercury-containing fluid includes an aqueous fluid.

15. The method of claim 13, wherein the mercury-containing fluid is a byproduct of crude oil production.

16. The method of claim 13, wherein the elemental sulfur is present as particles having a particle size ranging from 20 nm to 100 nm.

17. The method of claim 13, wherein the low-density polyethylene is present as a low-density polyethylene homopolymer.

18. The method of claim 17, wherein the weight percentage of the elemental sulfur in the mercury adsorbent material ranges from about 10 wt. % to about 20 wt. %.

19. The method of claim 17, wherein the mercury-containing fluid includes an aqueous fluid.

20. The method of claim 13, further including adjusting a temperature of the mercury-containing fluid to about 40° C.
